(19) United States
(12) Patent Application Publication
(10) Pub. No.: US 2002/0041129 A1
(43) Pub. Date: Apr. 11, 2002

(54) Stator for a dynamo-electric machine and method of manufacturing the same

(75) Inventors: Atsushi Oohashi, Tokyo (JP); Shoichiro Nishitani, Tokyo (JP)

Correspondence Address: SUGHRUE, MION, ZINN, MACPEAK & SEAS, 2100 Pennsylvania Avenue, N.W., Washington, DC, 20037, US

(73) Assignee: MITSUBISHI DENKI KABUSHIKI KAISHA

(21) Appl. No.: 09/888,656

(22) Filed: Jun. 26, 2001

(30) Foreign Application Priority Data
Oct. 10, 2000 (JP) 2000-309317

(51) Int. Cl. H02K 3/50

(52) U.S. Cl. 310/179; 29/596

(57) ABSTRACT

The present invention provides a stator for a dynamo-electric machine and a method for manufacturing the same in which an amount of heating during joining (welding) may be reduced, and, an insulating coating of conductors may be prevented form damage. In a stator 2 for a dynamo-electric machine comprising a stator core 32 having a plurality of slots 35, and a stator winding installed in the slots 35 and comprising a plurality of conductors 33 joint end portions 33a thereof joined to each other, joint portions of the joint end portions 33a comprise a molten metal 33g, 33 fof a lower melting point than that of the conductors 33.

### BACKGROUND OF THE INVENTION

1. Field of the Invention

The present invention relates to a stator for a dynamo-electric machine including a stator winding comprising a plurality of conductors which are joined to each other and a method for manufacturing the same, and, in particular, to improvements to joints portions of the conductors of the stator winding.

2. Description of the Related Art

FIG. 9 is a cross sectional view showing an entire construction of a conventional automotive alternator disclosed in, for example, Japanese Patent Application Laid-open No. HEI 11-341730. FIG. 10 is perspective view showing a portion of a stator, also disclosed in Japanese Patent Application Laid-open No. HEI 11-341730, in a condition where four (4) strands of conductors are inserted in each slot. In FIG. 9, an automotive alternator 1 includes a stator 2, a rotator 3, a frame 4, a rectifier 5, etc.

The stator 2 includes a stator core 32, conductor segments 33 as a plurality of electrical conductors comprising a stator winding, and insulators 34 for electrically insulating between the stator core 32 and the conductor segments 33. The stator core 32 is formed by laminating thin steel plates and a number of slots are formed at an inner circumferential surface thereof. Moreover, a coil end(s) 31 of the stator winding is formed by conductor segments 33 exposed from (protruding from) the stator core 32.

A stator 3 includes a magnetic field coil 8 of insulation treated copper wire wound concentrically in a cylindrical shape, a shaft 6 passing therethrough, and held between from both ends by means of pole cores 7 each having six (6) claw-shaped portions. Also, an axial flow type cooling fan 11 is attached, by welding and the like, to an end surface of the front-side pole core 7 in order to discharge in an axial and radial direction cooling air drawn in from the front side. Similarly, a centrifugal type cooling fan 12 is attached, by welding and the like, to an end surface of the rear-side pole core 7 in order to discharge in a radial direction cooling air drawn in from the rear side

The frame 4 houses the stator 2 and the rotor 3, the rotor 3 being supported thereat so as to be capable of rotating around the shaft 6, and the stator 2 fixed thereto disposed so as to introduce a predetermined gap between an outer circumferential side of the pole core 7 of the rotor 3. Moreover, cooling air discharge holes 42 and intake holes 41 are provided in portion of the frame 4 facing the coil ends 31 of the stator 2 and axial end surfaces, respectively.

In the above constructed automotive alternator 1, torque from an engine (not shown) is transferred to a pulley 20 via a belt and the like to rotate the rotor 3 in a predetermined direction. In this state, claw-shaped portions of the pole cores 7 are magnetized by application of an external field current to the magnetic field coil 8 of the rotor 3 and a three phase alternating voltage may be generated in the stator winding and a predetermined direct current is derived from an output terminal of the rectifier 5.

In FIG. 10, four (4) strands of conductor segments 33 housed in one (1) slot 35 alternately extend in circumferential directions. In the figure, strands nearest (the viewer) at the outermost circumference extend clockwise and strands positioned farthest away (from the viewer) at the inner most circumference extend counter clockwise. End portions 33a of each conductor segment 33 are joined with end portions 33a of other conductor segments 33 extending from other slots 35 a predetermined pitch away. Also in FIG. 10, the conductor segment 33 at the innermost circumference and the conductor segment 33 of the second layer are joined together and the conductor segment 33 of the third layer and the conductor segment 33 of the outermost layer are joined together. Accordingly, a plurality of joint portions 33b are aligned in two (2) toroidal rows at an inner circumferential side and an outer circumferential side, and joint portions 33b are disposed spaced from each other in both a circumferential direction and a radial direction. Also, the joint portions 33b are formed as spherical “rain-drop-shaped” portions without edges by means of TIG welding.

In a stator for a dynamo-electric machine structured as above, since joint portions 33b are heated to the melting point, or above, of the conductors 33 for welding, an insulating coating in the vicinity of the joint portions 33b is damaged and there is a concern that a short-circuit failure may occur between adjacent conductors.

Moreover, the conductors 33 are disposed in a dense arrangement, and since end portions 33a approach one another, there is a concern that end portions will become joined with other radially adjacent joint portions 33b if the heat source deviates from a prescribed target.

Furthermore, because the plurality of joint portions are sequentially welded one by one, productivity is bad.

### SUMMARY OF THE INVENTION

The present invention aims to solve the above problems with the conventional art and an object of the present invention is to provide a stator for a dynamo-electric machine and a method for manufacturing the same in which an amount of heating during joining (welding) may be reduced, and, an insulating coating of conductors may be prevented from damage.

In order to achieve the above object, according to one aspect of the present invention there is provided,

a stator for a dynamo-electric machine comprising:

a stator core having a plurality of slots, and a stator winding installed in the slots and comprising a plurality of conductors joint end portions thereof joined to each other; wherein,

joint portions of the joint end portions comprise a molten metal of a lower melting point than that of the conductors.

According to another aspect of the present invention there is provided a stator for a dynamo-electric machine wherein:

the molten metal is an alloy of a material of the conductors and an additive metal.

According to yet another aspect of the present invention there is provided a stator for a dynamo-electric machine wherein:

the additive metal is a Cu—P alloy.

According to still yet another aspect of the present invention there is provided a stator for a dynamo-electric machine wherein:

the additive metal is Ag or an Ag alloy.

According to still yet another aspect of the present invention there is provided a stator for a dynamo-electric machine wherein:

the additive metal is Sn or an Sn alloy.

According to still yet another aspect of the present invention there is provided a method for manufacturing a stator for a dynamo-electric machine comprising,

in a stator comprising a stator core having a plurality of slots, and a stator winding installed in the slots and comprising a plurality of conductors joint end portions thereof joined to each other,

an insert metal positioning process for placing an insert metal of a lower melting point than that of the conductors between the joint end portions of the conductors, and

after heating a vicinity of the joint end portions to a temperature at which the insert metal melts and the joint end portions do not melt and said insert metal is melted, a joining process for solidifying the insert metal and joining the joint end portions by ending the heating.

According to still yet another aspect of the present invention there is provided a method for manufacturing a stator for a dynamo-electric machine comprising,

in a stator comprising a stator core having a plurality of slots, and a stator winding installed in the slots and comprising a plurality of conductors joint end portions thereof joined to each other,

an insert metal positioning process for placing an insert metal of a lower melting point than that of the conductors between the joint end portions of the conductors, and

after heating a vicinity of the joint end portions to a temperature at which the insert metal melts and melt alloying conductor end portions and the insert metal, a joining process for solidifying the molten alloy and joining the joint end portions by ending the heating.

According to still yet another aspect of the present invention there is provided a method for manufacturing a stator for a dynamo-electric machine wherein:

pairs of the joint end portions to be joined align in a row of two (2) or more sets in a radial direction, and the insert metal is not provided between adjacent sets of the joint end portions.

According to still yet another aspect of the present invention there is provided a method for manufacturing a stator for a dynamo-electric machine wherein:

pairs of the joint end portions to be joined align in a row of a plurality of sets in a circumferential direction, and the insert metals provided between each the joint end portion is connected in a circumferential direction.

According to still yet another aspect of the present invention there is provided a method for manufacturing a stator for a dynamo-electric machine wherein:

a cross sectional area of a connecting portion of the insert metal is smaller than a cross sectional area of a portion between the joint end portions.

According to still yet another aspect of the present invention there is provided a method for manufacturing a stator for a dynamo-electric machine wherein:

the vicinity of the joint end portions is heated with a non-contact heat source in the joining process

According to still yet another aspect of the present invention there is provided a method for manufacturing a stator for a dynamo-electric machine wherein:

the joining process is resistance heating in which an electrode is contacted to said joint end portions and a current is conducted, two (2) or more sets of the joint end portions aligned in a radial direction being sandwiched together by two (2) electrodes disposed at an inner diameter side and an outer diameter side and heated.

According to still yet another aspect of the present invention there is provided a method for manufacturing a stator for a dynamo-electric machine wherein:

the two (2) electrodes disposed at an inner diameter side and an outer diameter side are each of a roller shape and heat, while rolling, an inner side and outer side of joint end portion groups aligned in a plurality of sets in a circumferential direction.

### BRIEF DESCRIPTION OF THE DRAWINGS

FIG. 1 is a perspective view showing a joined conductor portion of a stator for a dynamo-electric machine according to Embodiment 1 of the present invention.

FIG. 2 is process flow chart explaining a method of joining conductor end portions in Embodiment 1.

FIG. 3 is a perspective view showing a joined conductor portion of a stator for a dynamo-electric machine according to Embodiment 2 of the present invention.

FIG. 4 is a process flow chart explaining a method of joining conductor end portions in Embodiment 2.

FIG. 5 is a process flow chart explaining a method of manufacturing a stator for a dynamo-electric machine according to Embodiment 3.

FIG. 6 is a process flow chart explaining a method of manufacturing a stator for a dynamo-electric machine according to Embodiment 4.

FIG. 7 is a drawing showing conductor end groups before joining in another method of manufacturing a stator for a dynamo-electric machine according to Embodiment 5, as viewed from a direction of the axis of rotation of the dynamo-electric machine.

FIG. 8 is a drawing showing conductor end groups during joining in another method of manufacturing a stator for a dynamo-electric machine according to Embodiment 6, as viewed from a direction of the axis of rotation of the dynamo-electric machine.

FIG. 9 is a cross sectional view showing an entire construction of a conventional automotive alternator.

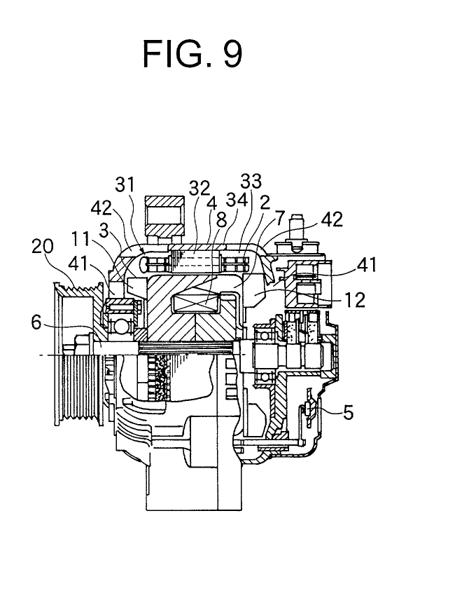

FIG. 10 is perspective view showing a portion of a stator in a condition where four (4) strands of conductors are inserted in each slot.

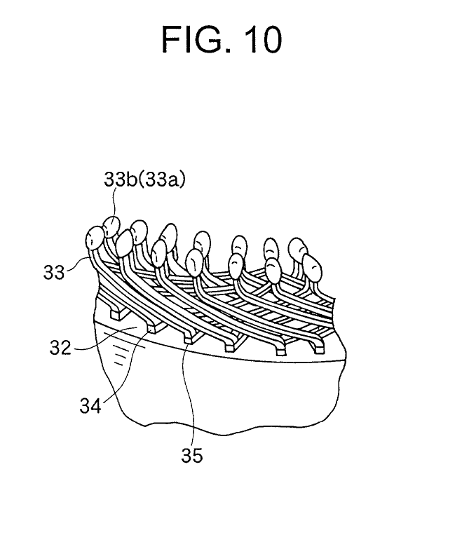

### DETAILED DESCRIPTION OF THE PREFERRED EMBODIMENTS

Embodiment 1

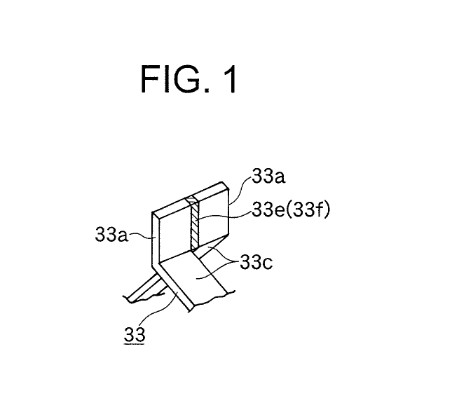

FIG. 1 is a perspective view showing a joined conductor portion of a stator for a dynamo-electric machine according to the present embodiment of the invention. In the present embodiment, an insulating coating 33c is stripped from end portions 33a of conductors 33 in advance. Joint portions 33e of joint end portions 33a comprise molten metal 33f of a lower melting point than that of the conductors 33. Other constructions are roughly similar to the conventional art.

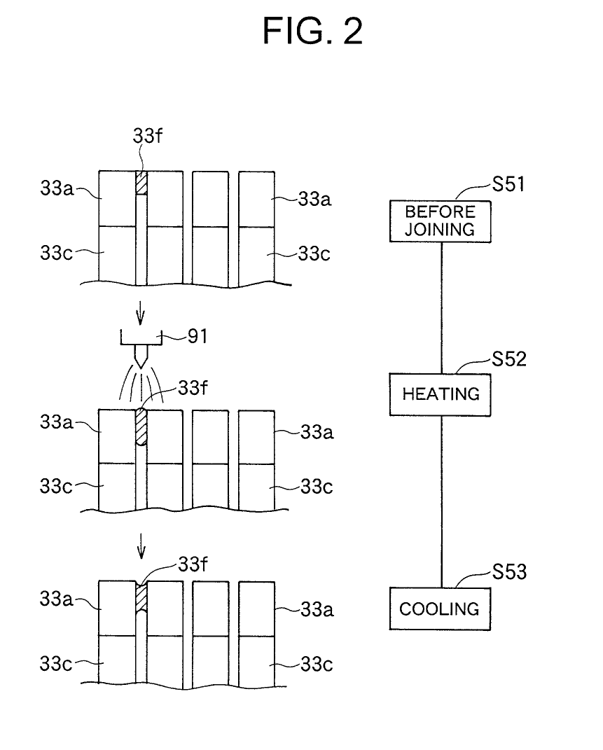

FIG. 2 is process flow chart explaining a method of joining conductor end portions in the present embodiment. In the present embodiment, first, in step S51, insert metal 33f with a melting point lower than that of the conductors 33 is placed between two (2) joint end portions 33a to be joined (insert metal positioning process). Moreover, the insulating coating 33c has been stripped from the end portions 33a of the conductors 33 in advance.

Next, in step S52, a vicinity of the joint end portions is heated to a temperature at which the insert metal 33f is melted and the joint end portions 33a do not melt. That is to say, only the insert metal 33f is melted. Moreover, an electric arc, which is a non-contact heat source, is employed as a heat source 91.

Then, in step S53, the insert metal 33f is solidified and the joint end portions 33a are joined by turning off the heat source 91 to end the heating (joining process).

Furthermore, a different non-contact heat source such as a plasma arc, laser, electron beam and the like may also be used as the heat source 91 in the joining process.

In the above stator for a dynamo-electric machine according to the present embodiment, joint portions 33e of the joint end portions 33a comprise molten metal 33f with a lower melting point than that of the conductors 33. Thus, it is possible to lower an amount of heat during heating, and, since a temperature rise in the conductors 33 may be suppressed, it is possible to prevent damage of the insulating coating 33c.

Also, the method of manufacturing the stator for a dynamo-electric machine according to the present embodiment includes: the insert metal positioning process (step S51) in which insert metal 33f of a melting point lower than that of the conductors 33 is placed between joint end portions 33a of conductors 33; and, after heating a vicinity of the joint end portions to a temperature at which the insert metal 33f melts and the joint end portions 33a do not melt and the insert metal 33f is melted (step S52), the joining process for solidifying the insert metal 33f and joining the joint end portions 33a by ending the heating (step S53?). Thus, it is possible to lower an amount of heat during heating, and, since a temperature rise in the conductors 33 may be suppressed, it is possible to prevent damage of the insulating coating 33c.

Moreover, heating the vicinity of the joint end portions is performed with a non-contact heat source. Thus, it is possible raise the temperature of the joint end portions to a welding temperature in a short period of time, and it is possible to prevent damage of the insulating coating 33c.

Embodiment 2

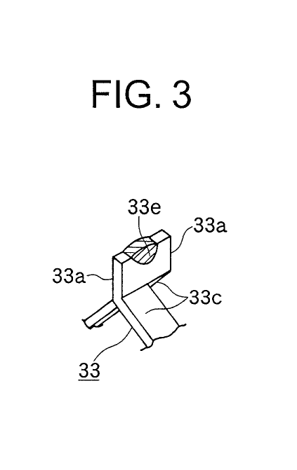

FIG. 3 is a perspective view showing a joined conductor portion of a stator for a dynamo-electric machine according to the present embodiment. In the present embodiment, joint portions 33e of the joint end portions 33a comprise an alloy of the conductors 33 and an additive metal 33g. The additive metal 33g is, for example, a Cu—P alloy, Ag or and Ag alloy, or, Sn or an Sn alloy. Other constructions are approximately the same as in Embodiment 1.

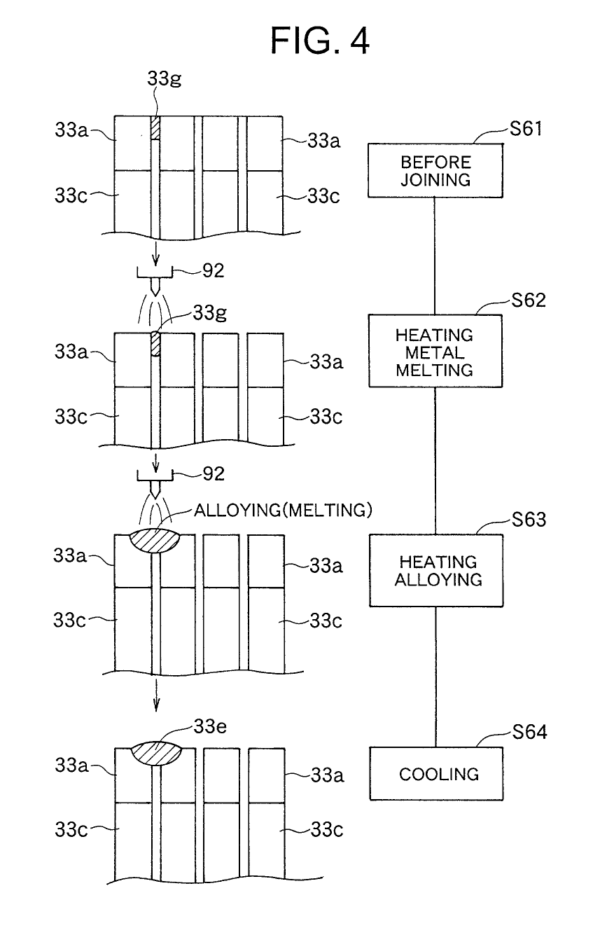

FIG. 4 is a process flow chart explaining a method of joining conductor end portions in the present embodiment. In the present embodiment, first, in step S61, insert metal (additive metal) 33g of a melting point lower than that of the conductors 33 is placed between two (2) joint end portions 33a to be joined (insert metal positioning process).

Next, in step S62, the insert metal 33g is melted by heating a vicinity of joint end portions, and, in step S63, the insert metal 33g and the conductors 33 are alloyed by further heating. That is, conductor end portions and the insert metal 33g are melt alloyed. Moreover, an electric arc, which is a non-contact heat source, is employed as a heat source 92.

Then, in step S64, the molten alloy is solidified and the joint end portions are joined by ending the heating (joining process).

In the above stator for a dynamo-electric machine according to the present embodiment, the molten metal 33g is an alloy of the material of the conductors 33 and the additive metal 33g. Thus, a strength of the joint portions 33e may be improved.

Also, the additive metal 33g is Cu—P alloy. Thus, when the conductors are copper, joining may be positively performed even if flux is not used, and subsequent treatment is unnecessary.

Further, the additive metal is Ag or Ag alloy. Hence, when the conductors are copper, an alloying reaction is brought about by a small amount of heat and it is possible to prevent damage of the insulating coating.

Moreover, the additive metal is Sn or Sn alloy. Thus, when the conductors are copper, an alloying reaction is brought about by a small amount of heat and it is possible to prevent damage of the insulating coating.

Furthermore, the method of manufacturing the stator for a dynamo-electric machine according to the present embodiment includes: the insert metal positioning process (step 61) in which insert metal 33g of a melting point lower than that of the conductors 33 is placed between joint end portions 33a of conductors 33; and, after heating a vicinity of the joint end portions to a temperature at which the insert metal 33g melts and melt alloying the conductor end portions and the insert metal 33g (steps 62, 63), the joining process for solidifying the molten metal 33f and joining the joint end portions 33a by ending the heating (step S64). Thus, the insert metal 33g melt alloys with the conductors and the strength of the joint portions 33e may be increased.

Moreover, in the method of manufacturing the stator for a dynamo-electric machine according to the present embodiment, although the insert metal 33g is employed for melt alloying with the conductor end portions, similar effects may also be obtained by coating on the conductors 33 a plating material of a lower melting point than that of the conductors 33, or by supplying a filler rod of a lower melting point than that of the conductors 33.

Embodiment 3

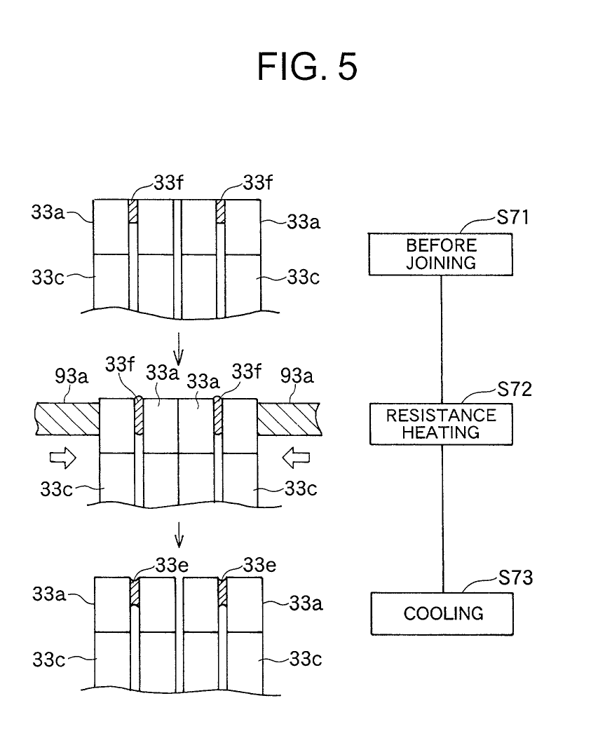

FIG. 5 is a process flow chart explaining a method of manufacturing a stator for a dynamo-electric machine according to the present embodiment. In the present embodiment, first, in step S71, insert metal (additive metal) 33f of a melting point lower than that of the conductors 33 is placed, respectively, between joint end portions 33a in two (2) sets thereof to be joined (insert metal positioning process).

Next, in step S72, two sets of joint end portions 33a aligned in a row in a radial direction are sandwiched together by two (2) electrodes 93a, 93b disposed at an inner diameter side and an outer diameter side and pressed while a voltage is applied. In the two (2) sets of joint end portions 33a, the two (2) joint end portions 33a at an inner side are pressed together from both sides and contacted, a current is flowed between the electrodes 93a, 93b and the insert metal is melted by resistance heating.

Then, in step S73, the current is stopped before the conductors 33 melt and the insert metal 33f solidifies and the joint end portions 33a are joined (joining process).

In the method of manufacturing the stator for a dynamo-electric to be joined are aligned in rows of two (2) sets in a radial direction and insert metal 33f is not placed between joint end portions 33a of adjacent sets. Thus, since insert metal 33f is not placed between joint end portions 33a of adjacent sets, joint end portions of different sets are not connected.

Also, In the method of manufacturing the stator for a dynamo-electric machine according to the present embodiment, step S71 is resistance heating in which the electrodes 93a, 93b are contacted to joint end portions 33a and a current is conducted to generate heat, and the joint end potions 33a aligned in rows of two (2) sets in a radial direction are sandwiched together by the two (2) electrodes 93a, 93b disposed at an inner diameter side and an outer diameter side and heated. Hence, productivity is improved because it is possible to simultaneously join the plurality of joint end portions aligned in a radial direction.

Moreover, in the present embodiment, although the pairs of joint end portions 33a to be joined are aligned in rows of two (2) sets in a radial direction, even if pairs of joint end portions 33a to be joined are aligned in rows of two (2) or more sets, it is still possible to sandwiched them together by the two (2) electrodes 93a, 93b and conduct heating.

Embodiment 4

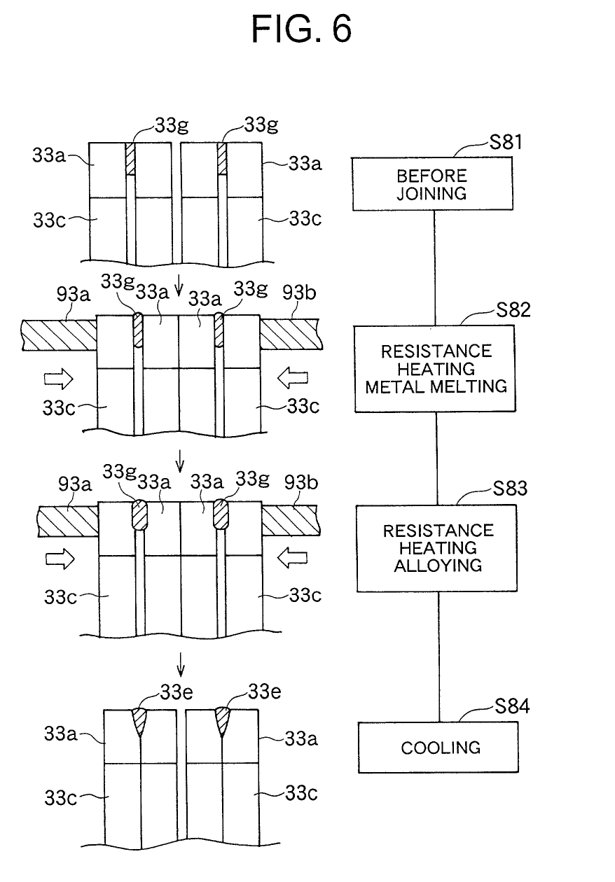

FIG. 6 is a process flow chart explaining a method of manufacturing a stator for a dynamo-electric machine according to the present embodiment. In the present embodiment, first, in step S81, insert metal (additive metal) 33g of a melting point lower than that of the conductors 33 is placed, respectively, between joint end portions 33a in two (2) sets thereof to be joined (insert metal positioning process).

Next, in step S82, two sets of joint end portions 33a aligned in a row in a radial direction are sandwiched together by two (2) electrodes 93a, 93b disposed at an inner diameter side and an outer diameter side and pressed while a voltage is applied. in the two (2) sets of joint end portions 33a, the two (2) joint end portions 33a at an inner side are pressed together from both sides and contacted, a current is flowed between the electrodes 93a, 93b and the insert metal is melted by resistance heating. Then, in step S83, further welding is carried out to melt alloy the insert metal 33g and the conductors 33.

Then, in step S84, the current is stopped and the insert metal 33f solidifies and the joint end portions 33a are joined coining process).

In the method of manufacturing the stator for a dynamo-electric machine according to the present embodiment, steps S82, S83 are resistance heating in which the electrodes 93a, 93b are contacted to joint end portions 33a and a current is conducted to generate heat, and the joint end potions 33a aligned in rows of two (2) sets in a radial direction are sandwiched together by the two (2) electrodes 93a, 93b disposed at an inner diameter side and an outer diameter side and heated. Hence, productivity is improved because it is possible to simultaneously join the plurality of joint end portions aligned in a radial direction.

Embodiment 5

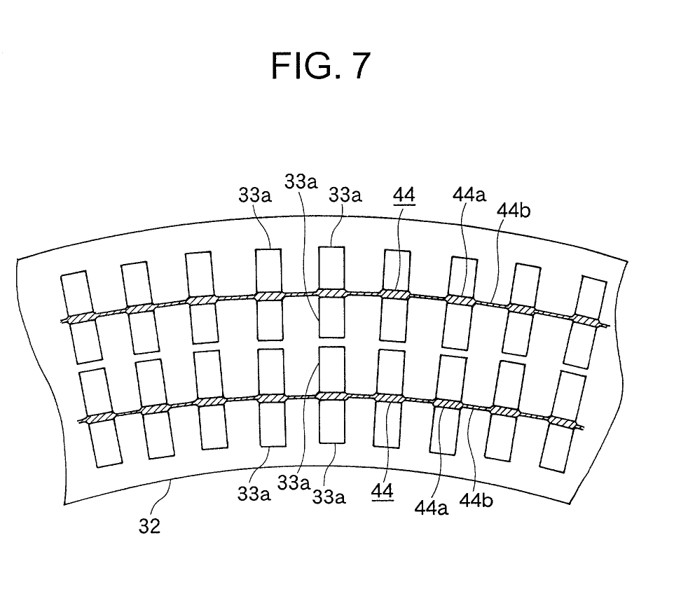

FIG. 7 is a drawing showing conductor end groups before joining in another method of manufacturing a stator for a dynamo-electric machine according to this embodiment of the present invention, as viewed from a direction of the axis of rotation of the dynamo-electric machine. In the present embodiment, pairs of joint end portions 33a to be joined are aligned in rows of two (2) sets in a radial direction and in rows of a plurality of sets in a circumferential direction. Pieces of insert metal 44 placed between conductor end portions 33a aligned in a circumferential direction are (themselves) connected, and further, a cross sectional area of such a connecting portion 44b is smaller than that of a potion 44a placed between conductor end portions. Other constructions are similar to those in Embodiment 3 or 4. The connecting portions 44b of a small cross sectional area are naturally melted by heat during welding so that each joint portion 44a separates and becomes independent

In the method of manufacturing the stator for a dynamo-electric machine according to the present embodiment, pairs of joint end portions 33a to be joined are aligned in a plurality of sets in a circumferential direction and insert metal 44 placed between conductor end portions 33a are (themselves) connected in a circumferential direction. Thus, since the insert metal 44 is connected, the operation of placing the insert metal 44 between joint end portions 33a in the plurality of sets is facilitated and workability is improved.

A cross sectional area of a connecting portion 44b of the insert metal 44 is smaller than a cross sectional area of a portion 44a between the joint end portions. Hence, because the connecting portions 44b are naturally melted by heat during welding so that each joint portion 44a separates and becomes independent, an operation for cutting the connecting portions 44b becomes unnecessary and workability is improved.

Embodiment 6

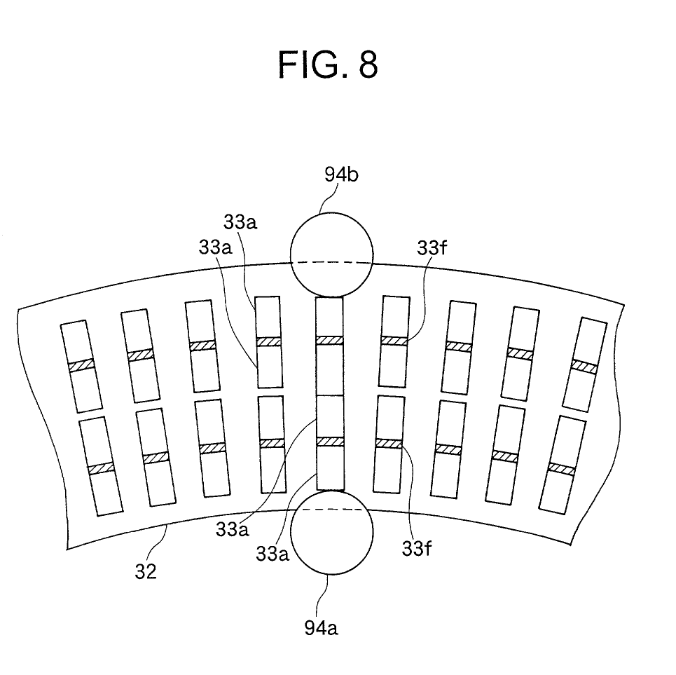

FIG. 8 is a drawing showing conductor end groups during joining in another method of manufacturing a stator for a dynamo-electric machine according to this embodiment of the present invention, as viewed from a direction of the axis of rotation of the dynamo-electric machine. In the present embodiment, pairs of joint end portions 33a to be joined are aligned in rows of two (2) sets in a radial direction. The pairs of joint end portions 33a aligned in rows of two (2) sets in a radial direction are sandwiched together by two (2) electrodes 94a, 94b, each being roller shaped, disposed at an inner diameter side and an outer diameter side, and inner and outer sides of a plurality of joint end portions groups aligned in rows in a circumferential direction are rolled while energizing to conduct resistance heating. Other constructions are similar to those in embodiments 3 or 4

In the method of manufacturing the stator for a dynamo-electric machine according to the present embodiment, two (2) electrodes 94a, 94b, each being roller shaped are disposed at an inner diameter side and an outer diameter side, and inner and outer sides of a plurality of joint end portions groups aligned in rows in a circumferential direction are rolled while energizing to conduct resistance heating. Thus, it is possible to simultaneously join the plurality of joint end portions 33a aligned in a radial direction and connect the plurality of joint end portions 33a aligned in a circumferential direction, the joining operation is performed in a short period of time, and productivity is improved.

Moreover, in the present embodiment, although pairs of joint end portions 33a to be joined are aligned in rows of two (2) sets in a radial direction, even if pairs of joint end portions 33a to be joined are aligned in rows of two (2) or more sets, it is still possible to sandwich them together with the two (2) electrodes 94a, 94b and conduct heating.

In order to achieve the above object, according to one aspect of the present invention there is provided,

a stator for a dynamo-electric machine comprising:

a stator core having a plurality of slots, and a stator winding installed in the slots and comprising a plurality of conductors joint end portions thereof joined to each other; wherein,

joint portions of the joint end portions comprise a molten metal of a lower melting point than that of the conductors. Thus, it is possible to lower an amount of heat during heating, and, since a temperature rise in the conductors may be suppressed, it is possible to prevent damage of the insulating coating.

According to another aspect of the present invention there is provided a stator for a dynamo-electric machine wherein:

the molten metal is an alloy of a material of the conductors and an additive metal. Hence, the strength of the joint portions may be increased.

According to yet another aspect of the present invention there is provided a stator for a dynamo-electric machine wherein:

the additive metal is a Cu—P alloy. Thus, when the conductors are copper, joining may be positively performed even if flux is not used, and subsequent treatment is unnecessary.

According to still yet another aspect of the present invention there is provided a stator for a dynamo-electric machine wherein:

the additive metal is Ag or an Ag alloy. Hence, when the conductors are copper, an alloying reaction is brought about by a small amount of heat and it is possible to prevent damage of the insulating coating.

According to still yet another aspect of the present invention there is provided a stator for a dynamo-electric machine wherein:

the additive metal is Sn or an Sn alloy. Thus, when the conductors are copper, an alloying reaction is brought about by a small amount of heat and it is possible to prevent damage of the insulating coating.

According to still yet another aspect of the present invention there is provided a method for manufacturing a stator for a dynamo-electric machine comprising,

in a stator comprising a stator core having a plurality of slots, and a stator winding installed in the slots and comprising a plurality of conductors joint end portions thereof joined to each other,

an insert metal positioning process for placing an insert metal of a lower melting point than that of the conductors between the joint end portions of the conductors, and

after heating a vicinity of the joint end portions to a temperature at which the insert metal melts and the joint end portions do not melt and the insert metal is melted, a joining process for solidifying the insert metal and joining the joint end portions by ending the heating.

Thus, it is possible to lower an amount of heat during heating, and, since a temperture rise in the conductor may be suppressed, it is possible to prevent damage of the insulating coating.

According to still yet another aspect of the present invention there is provided a method for manufacturing a stator for a dynamo-electric machine comprising,

in a stator comprising a stator core having a plurality of slots, and a stator winding installed in the slots and comprising a plurality of conductors joint end portions thereof joined to each other,

an insert metal positioning process for placing an insert metal of a lower melting point than that of the conductors between the joint end portions of the conductors, and

after heating a vicinity of the joint end portions to a temperature at which the insert metal melts and melt alloying conductor end portions and the insert metal, a joining process for solidifying the molten alloy and joining the joint end portions by ending the heating.

Thus, the insert metal melt alloys with the conductors and the strength of the joint portions may be increased.

According to still yet another aspect of the present invention there is provided a method for manufacturing a stator for a dynamo-electric machine wherein:

pairs of the joint end portions to be joined align in a row of two (2) or more sets in a radial direction, and the insert metal is not provided between adjacent sets of the joint end portions. Hence, since insert metal is not placed between adjacent sets of conductors, joint portions of different sets are not joined.

According to still yet another aspect of the present invention there is provided a method for manufacturing a stator for a dynamo-electric machine wherein:

pairs of the joint end portions to be joined align in a row of a plurality of sets in a circumferential direction, and the insert metal provided between each joint end portion is connected in a circumferential direction. Thus, because the insert metal is connected, the operation of placing insert metal between joint end portions in the plurality of sets is facilitated.

According to still yet another aspect of the present invention there is provided a method for manufacturing a stator for a dynamo-electric machine wherein:

a cross sectional area of a connecting portion of the insert metal is smaller than a cross sectional area of a portion between the joint end portions. Hence, because the connecting portions are naturally melted by heat during welding so that each joint portion separates and becomes independent, an operation for cutting the connecting portions becomes unnecessary and workability is improved.

According to still yet another aspect of the present invention there is provided a method for manufacturing a stator for a dynamo-electric machine wherein:

the vicinity of the joint end portions is heated with a non-contact heat source in the joining process. Thus, it is possible raise the temperature of the joint end portions to a welding temperature in a short period of time, and it is possible to prevent damage of the insulating coating.

According to still yet another aspect of the present invention there is provided a method for manufacturing a stator for a dynamo-electric machine wherein:

the joining process is resistance heating in which an electrode is contacted to said joint end portions and a current is conducted, two (2) or more sets of the joint end portions aligned in a row in a radial direction being sandwiched together by two (2) electrodes disposed at an inner diameter side and an outer diameter side and heated. Hence, productivity is improved because it is possible to simultaneously join the plurality of joint end portions aligned in a radial direction.

According to still yet another aspect of the present invention there is provided a method for manufacturing a stator for a dynamo-electric machine wherein:

the two (2) electrodes disposed at an inner diameter side and an outer diameter side are each of a roller shape and heat, while rolling, an inner side and outer side of joint end portion groups aligned in a plurality of sets in a circumferential direction. Thus, it is possible to simultaneously join the plurality of joint end portions aligned in a radial direction and connect the plurality of joint end portions aligned in a circumferential direction, the joining operation is performed in a short period of time, and productivity is improved.

What is claimed is:

1. A stator for a dynamo-electric machine comprising:
a stator core having a plurality of slots, and a stator winding installed in said slots and comprising a plurality of conductors joint end portions thereof joined to each other; wherein,
joint portions of said joint end portions comprise a molten metal of a lower melting point than that of said conductors.

2. A stator for a dynamo-electric machine according to claim 1 wherein:
said molten metal is an alloy of a material of said conductors and an additive metal.

3. A stator for a dynamo-electric machine according to claim 2 where:
said additive metal is a Cu—P alloy.

4. A stator for a dynamo-electric machine according to claim 2 wherein:
said additive metal is Ag or an Ag alloy.

5. A stator for a dynamo-electric machine according to claim 2 wherein:
said additive metal is Sn or an Sn alloy.

6. A method for manufacturing a stator for a dynamo-electric machine comprising,
in a stator comprising a stator core having a plurality of slots, and a stator winding installed in said slots and comprising a plurality of conductors joint end portions thereof joined to each other,
an insert metal positioning process for placing an insert metal of a lower melting point than that of said conductors between said joint end portions of said conductors, and
after heating a vicinity of said joint end portions to a temperature at which said insert metal melts and said joint end portions do not melt and said insert metal is melted, a joining process for solidifying said insert metal and joining said joint end portions by ending said heating.

7. A method for manufacturing a stator for a dynamo-electric machine comprising,
in a stator comprising a stator core having a plurality slots, and a stator winding installed in said slots and comprising a plurality of conductors joint end portions thereof joined to each other.
an insert metal positioning process for placing an insert metal of a lower melting point than that of said conductors between said joint end portions of said conductors, and
after heating a vicinity of said joint end portions to a temperature at which said insert metal melts and melt alloying conductor end portions and said insert metal, a joining process for solidifying said molten alloy and joining said joint end portions by ending said heating.

8. A method for manufacturing a stator for a dynamo-electric machine according to claim 6 wherein:
pairs of said joint end portions to be joined align in a row of two (2) or more sets in a radial direction, and said insert metal is not provided between adjacent sets of said joint end portions.

9. A method for manufacturing a stator for a dynamo-electric machine according to claim 6 wherein:
pairs of said joint end portions to be joined align in a row of a plurality of sets in a circumferential direction, and said insert metal provided between each said joint end portion is connected in a circumferential direction.

10. A method for manufacturing a stator for a dynamo-electric machine according to claim 9 wherein:
a cross sectional area of a connecting portion of said insert metal is smaller than a cross sectional area of a portion between said joint end portions.

11. A method for manufacturing a stator for a dynamo-electric machine according to claim 6 wherein:
said vicinity of said joint end portions is heated with a non-contact heat source in said joining process.

12. A method for manufacturing a stator for a dynamo-electric machine according to claim 9 wherein:
said joining process is resistance heating in which an electrode is contacted to said joint end portions and a current is conducted, two (2) or more sets of said joint end portions aligned in a radial direction being sandwiched together by two (2) electrodes disposed at an inner diameter side and an outer diameter side and heated.

13. A method for manufacturing a stator for a dynamo-electric machine according to claim 12 wherein:
said two (2) electrodes disposed at an inner diameter side and an outer diameter side are each of a roller shape and heat, while rolling, an inner side and outer side of joint end portion groups aligned in a row of a plurality of sets in a circumferential direction.
